(19) United States
(12) Patent Application Publication
(10) Pub. No.: US 2003/0133410 A1
(43) Pub. Date: Jul. 17, 2003

(54) Subscriber routing setting method and recoding device using traffic information

(76) Inventors: Young-Hyun Kang, Seoul (KR); Tuck-Hoon Kim, Seoul (KR)

Correspondence Address: MATTINGLY, STANGER & MALUR, P.C., 1800 DIAGONAL ROAD, SUITE 370, ALEXANDRIA, VA, 22314, US

(21) Appl. No.: 10/330,286

(22) Filed: Dec. 30, 2002

(30) Foreign Application Priority Data
Jan. 11, 2002 (KR) 2002-1682

(51) Int. Cl. H04J 1/16; H04L 12/28

(52) U.S. Cl. 370/230; 370/397

(57) ABSTRACT

The present invention discloses a method for setting a subscriber routing using traffic information through networks, comprising the steps of classifying a traffic grade deciding the availability of network elements, after acquiring traffic information of the network elements by using a first information of configuration and connection states of the network elements collected for network management through the networks, and by using a second information calculated by assigning weight-value to a predefined each variable of the network elements, selecting a less traffic unit or port by the classified traffic grade in the case of requests for setting a connection routing path for a new subscriber through the networks, and setting final connection routing path by selecting an available subscriber connection a virtual path identifier/virtual channel identifier (VPI/VCI) in a selected unit or port. As a result, The present invention analyzes the entire network states through the network management system/element management system (NMS/EMS) to perform a routing to allow quick and correct routing setting.

### CLAIM OF PRIORITY

This application makes reference to, incorporates the same herein, and claims all benefits accruing under 35 U.S.C §119 from an application entitled “Method And Recorded Media For Setting The Subscriber Routing Using Traffic Information earlier filed in the Korean Industrial Property Office on Jan. 11, 2002, and there duly assigned Serial No. 2002-1682 by that Office.

### BACKGROUND OF THE INVENTION

1. Field of the Invention

The present invention relates to a method for setting a subscriber routing of a network element (NE) in a communication network of an asynchronous transfer mode (ATM), and more particularly, to a method for setting a subscriber routing and a recording device using traffic information from a network management system (NMS) or an element management system (EMS).

2. Description of the Related Art

FIG. 1 is a schematic exemplary block diagram of a network management system (NMS). Referring to FIG. 1, the NMS comprises a network management server 10 for managing all of the networks, and an NMS client 20 for receiving all information from the network management server 10 and for setting and searching a subscriber routing path.

Generally, the NMS server 10 manages multiple network elements connected with the networks. In other words, the NMS server 10 informs actual states of equipment to an operator, and settles troubles of equipment quickly.

The NMS server 10 normally gives subscriber path setting orders through the networks comprising each network element to set subscriber routing paths. Therefore, when a predefined path L1 becomes traffic congested, another alternate path L2 can be defined.

For setting a subscriber path, permanent virtual circuit (PVC) or switched virtual circuit (SVC) can be used. In the case of the permanent virtual circuit, each network element sets a subscriber path. Therefore, when traffic congestion happens before setting an alternate subscriber path, the permanent virtual circuit generates error or cell loss.

Additionally, even though the switched virtual circuit finds an optimum route to set a subscriber path through a connection admission control (CAC) and a usage parameter control (UPC), the switched virtual circuit receives traffic congestion in the adjacent network element to switch or change the subscriber path.

In the exemplary traffic control method in each network element, a reactive control method and a preventive control method exist.

FIG. 2 is a concept diagram illustrating the reactive control method and the preventive control method. Referring to FIG. 2, the reactive control method and the preventive control method will be illustrated in the following statements.

In the networks comprising multiple network elements 1-6, the reactive control method transmits data through the network elements 1-2-3-4 according to the predefined subscriber path. When a predetermined network element, for example network element 3, gets traffic congestion, the network element 3 generates cell loss and generates alarms about the traffic congestion. Sequentially, the network element 1 receiving the alarm finds a new alternate path via network elements 5 and 6, or controls to close the predefined path including the traffic congested network element 3. In other words, the reactive control method receives the states of the next network element, and acts to control such traffic congested states.

On the contrary, the preventive control method collects information about adjacent network elements 2-6 previously to decide whether the adjacent network elements 2-6 are in good states or not. When the network element 3 gets troubles, the preventive control method avoids the subscriber path including the network element 3, and sets a route through the good network elements 5-6-4 to transmit cell data.

As described in the above statements, the preventive control method collects information of the adjacent network elements to prevent cell loss due to the traffic congested network element. However, the preventive control method gets information about the adjacent network elements only. In other words, the preventive control method does not get any information whether the network states after the network element 6 are good or not.

For getting information about all states of the networks, lots of calculations should be requested. Therefore, calculation delays and eventually cell loss are generated. As a result, it is not a proper situation in an information super-highway.

Therefore, in the described reactive control method and the preventive control method, each network element makes a determination to define the subscriber path. As a result, calculation delays are generated, and it is not an efficient way to actually find a subscriber path as recognizing traffic congestion of all networks.

In other words, the reactive control method has problems in changing a subscriber path after getting errors or cell loss. On the contrary, because the preventive control method should understand traffic states of all networks in real time, the preventive control method grasps information for the adjacent network element in present time to set a subscriber path. Therefore, when the next network element gets traffic congestion, the preventive control method also gets error or cell loss in the same way of the reactive control method.

### SUMMARY OF THE INVENTION

To overcome the above described problems, preferred embodiments of the present invention provide a method for a setting a subscriber routing and a recording device using traffic information for calculating traffic of each network element in real time by a network management device to display the traffic information through a network topology viewer, instead of by each network element, for finding a best good subscriber path to a newly connected subscriber, and for providing a less traffic congested route to the subscribers.

In order to achieve the above object, the preferred embodiment of the present invention provides a method for setting a subscriber routing using traffic information through the networks, comprising the steps of: classifying a traffic grade deciding the availability of network elements, after acquiring traffic information of the network elements by using a first information of configuration and connection states of the network elements collected for network management through the networks, and by using a second information calculated by assigning a weight-value to a predefined variable of each of the network elements; selecting a less busy traffic unit or port by the classified traffic grade in the case of requests for setting a connection routing path for a new subscriber through the networks; and setting a final connection routing path by selecting an available subscriber connection virtual path identifier/virtual channel identifier (VPI/VCI) in a selected unit or port.

Additionally, the network management through the networks in the step of classifying a traffic grade uses traffic information of the NMS/EMS (network management system/element management system).

Also, the first information includes at least one of alarm states information, or the number of hops among the network elements.

Further, the second information includes at least one of a traffic descriptor, a class of service (CoS), a quality of service (QoS), or a type of service (ToS) for each subscriber allocated to the network elements.

Further yet, the step of classifying the traffic grade comprises the steps of: deciding the availability in each of the network elements by the first information; and classifying the traffic grade of the available network elements by the second information.

Another purpose of the present invention is to provide a method for setting a subscriber routing using traffic information through the networks, comprising the steps of: selecting a setting-possible path according to links and topologies between a starting point and an ending point after receiving the starting point and the ending point of network elements for setting a routing path through a network management for the networks; analyzing objective units in the selected setting path, ports in each unit, and the subscriber connection states in each port; setting VPI/VCI of the starting point and the ending point to a selected port with a minimum weight-value after calculating weight-value for the degree of the traffic congestions of corresponding subscribers in each corresponding port; and setting a cross-connection between the corresponding network intervals by transmitting the selected path information to the corresponding network elements.

Additionally, the step of selecting a setting-possible path according to links and topologies comprises the steps of: selecting a path going through minimum number of hops between the starting point and the ending point; and selecting a path having a trunk with a lower bandwidth usage, in the case that several paths go through the same number of hops.

Also, the step of analyzing the subscriber connection states in each port analyzes alarm information in each unit/port to classify traffic items in each path.

Further, the step of setting VPI/VCI of the starting point and the ending point considers a traffic descriptor as a primary factor, and the CoS, QoS, and/or ToS as a secondary factor to assign weight-value.

Yet another purpose of the present invention is to provide a recording device for performing subscriber routing setting method using traffic information, embodying programs of commands executed by a digital processing device, and readable by the digital processing device, the recording device performing processes comprising the steps of: classifying a traffic grade deciding the availability of network elements, after acquiring traffic information of the network elements by using a first information of configuration and connection states of the network elements collected for network management through the networks, and by using a second information calculated by assigning a weight-value to a predefined variable of each of the network elements; selecting a less busy traffic unit or port by the classified traffic grade in the case of requests for setting a connection routing path for a new subscriber through the networks; and setting a final connection routing path by selecting an available subscriber connection virtual path identifier/virtual channel identifier (VPI/VCI) in a selected unit or port.

Still another purpose of the present invention is to provide a recording device for performing a subscriber routing setting method using traffic information, embodying programs of commands executed by a digital processing device, and readable by the digital processing device, the recording device performing processes comprising the steps of: selecting a setting-possible path according to links and topologies between a starting point and an ending point after receiving the starting point and the ending point of network elements for setting a routing path through a network management for the networks; analyzing objective units in the selected setting path, ports in each unit, and the subscriber connection states in each port; setting virtual path identifier/virtual channel identifier (VPI/VCI) of the starting point and the ending point to a selected port with a minimum weight-value after calculating a weight-value for the degree of traffic congestions of corresponding subscribers in each corresponding port; and setting a cross-connection between the corresponding network intervals by transmitting the selected path information to the corresponding network elements.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a schematic exemplary block diagram of a network management system (NMS);

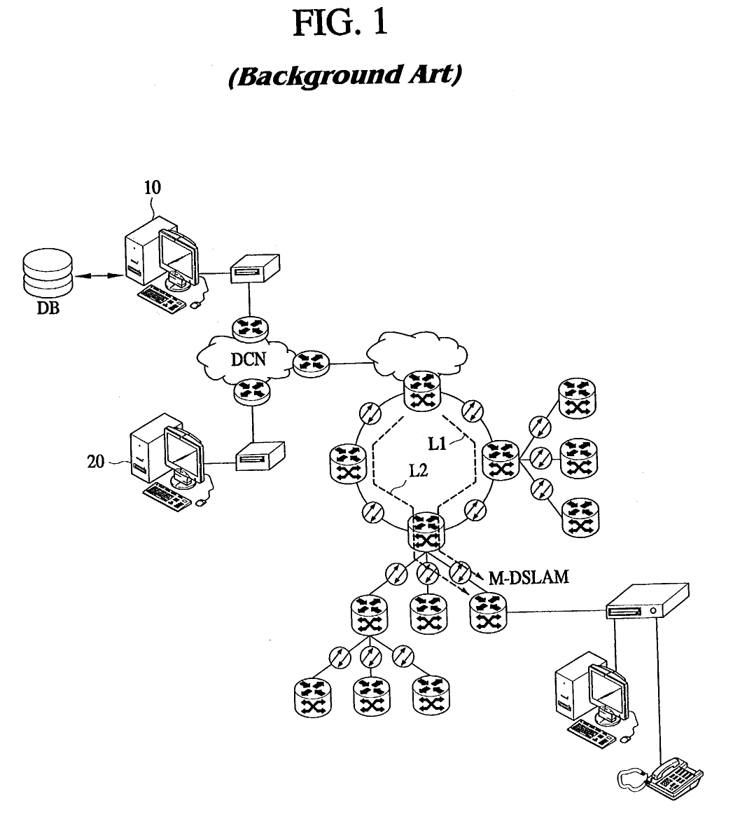

FIG. 2 is a concept diagram illustrating a reactive control method and a preventive control method;

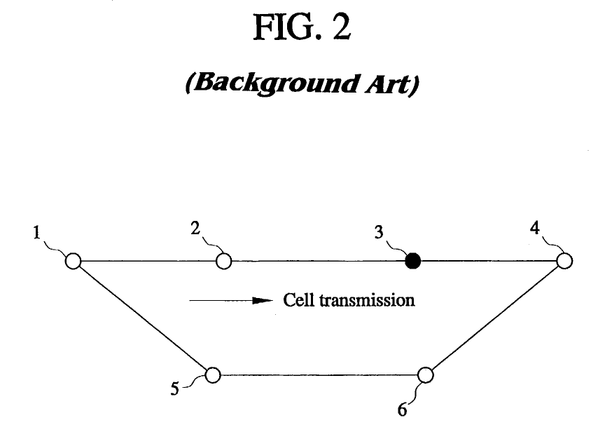

FIG. 3 is an entire systematic concept diagram illustrating the networks performing a subscriber routing setting using traffic information according to a preferred embodiment of the present invention;

FIG. 4 is a flow chart illustrating an operation of setting routing path for a new subscriber by using traffic information collected by a network management system (NMS) server of the present invention; and

FIG. 5 is a flow chart illustrating procedure of searching a detour when traffic information collected by the network management system (NMS) server shows errors generated by traffic congestion, according to the preferred embodiment of the present invention.

### DETAILED DESCRIPTION OF PREFERRED EMBODIMENTS

Reference will now be made in detail to preferred embodiments of the present invention, example of which is illustrated in the accompanying drawings.

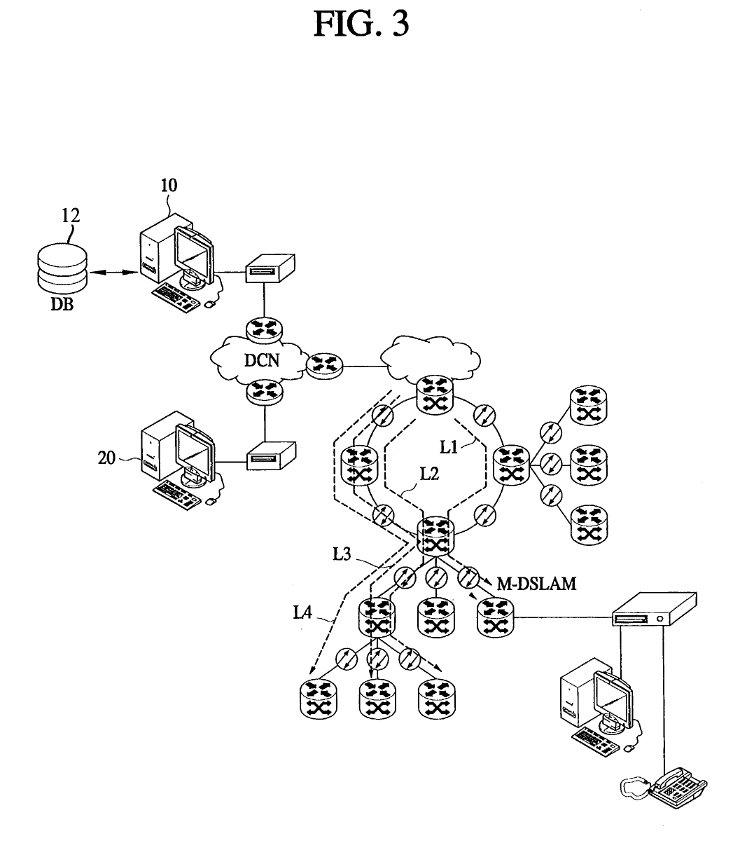

FIG. 3 is an entire systematic concept diagram illustrating the networks performing a subscriber routing setting using traffic information according to the preferred embodiment of the present invention.

Referring to FIG. 3, the network management system (NMS) server 10 calculates a traffic descriptor, a class of service (CoS), a quality of service (QoS), a type of service (ToS), and alarm information, collected in a database (DB) 12, for each of all subscribers allocated in each network element using a weight-value calculation method to classify a traffic grade. Additionally, when a new subscriber connection service is provided based on the calculated weight-value for each network element (each shelf or each area), the network management system server 10 selects less congested traffic unit or port automatically, searches a possible subscriber connection virtual path identifier/virtual channel identifier (VPI/VCI) for the selected traffic unit or port, and provides an optimum VPI/VCI (L1, L2, L3 and L4). The network management system client 20 can select an optimum permanent virtual circuit/switched virtual circuit (PVC/SVC) by selecting a route among all of the routes.

Such a network control method by the network management system sever 10 is defined as “Forecasting Control” in this application. In other words, the forecasting control method predefines the route like the reactive control method, and grasps information for not only the adjacent network elements like the preventive control method, but also all network elements by using the network management system to select an optimum routing path.

When the network management system server 10 manages the networks, a traffic grade for deciding usability of each network element is classified by using the configuration states of each network element through the networks, information collected for connection states and information calculated by assigning weights to each variables predefined for each network element.

Additionally, when receiving network management orders through networks, the network management system server 10 performs network management following the network management orders by using collected information for the corresponding network element and traffic grade. The information collected for the configuration states and connection states for each network element through the networks includes alarm information, the number of hops among each network element, and so on.

On the contrary, in the information calculated by assigning a weight to each variable predefined for each network element, lots of information can be included. In other words, a traffic descriptor, a class of service (CoS), a quality of service (QoS), a type of service (ToS) for each subscriber allocated in each network element can be included.

The traffic parameter for calculating degrees of traffic congestion by the weight-value can be defined like the table 1.

TABLE 1

| Variable | Detail Items |
|---|---|
| Alarm Information | Critical / Major / Minor |
| The Number of Hops | Maximum 12 Hops |
| Bandwidth Usage | [ ] bps |
| Traffic Descriptor | PCR / SCR / MBS / CDVT |
| CoS | CBR / UBR / rt-VBR / nrt-VBR / ABR / GFR |
| QoS | TM 3.0 / 4.0 |
| ToS | POTS / ISDN / xDSL / VoDSL / ATM |

Assigning a weight-value to each traffic parameter of Table 1 is the reason that each traffic parameter is an important variable in determining traffic in each network element.

In other words, it is necessary to have information for each operating network element previously before setting a routing path for a new subscriber to find an optimum path with less traffic.

The previous information includes how many hops are in the corresponding network element, whether the corresponding network element generates an alarm or not, the degree of the generated alarm, bandwidth usage of subscribers allocated in the corresponding network element, characteristic of traffic descriptor, a class of service (CoS), a quality of service (QoS) and a type of service (ToS).

When the corresponding network element generates an alarm, the degree of the alarm will vary. Therefore, the alarm can be classified into several steps such as critical, major or minor.

It is preferable to set a subscriber path without any alarm. However, the second best follow-up measures can be considered according to the degree of the alarm when there is no subscriber path without any alarm.

On the contrary, it is preferable to select a subscriber path with as few hops in the corresponding network element as possible. For example, when the maximum number of hops is more than 12, it will not be a desired subscriber path. Therefore, a subscriber path with a few hops will be selected at first. When the number of hops between the considered network element is the same, then the subscriber path will be determined by calculating the weight-value of other variables.

Additionally, it will be considered whether the bandwidth usage of the corresponding network element is below a predetermined critical value while operating the predefined communication networks or not. It is preferable that the bandwidth usage of the corresponding network element is within 50%. Therefore, when the bandwidth usage is more than 70%, it is required to extend communication lines passing the corresponding network element. When the bandwidth usage is more than 70%, it suggests that the bandwidth usage will be increased more than 70%.

Additionally, the traffic usage of the corresponding network element can be grasped through the a class of service (CoS). The CoS is determined when a subscriber line is newly established. Therefore, traffic usage by the subscriber line allocated to the corresponding network element is known clearly. For example, when the CoS is CBR, the bandwidth usage is not variable. In other words, the corresponding network element has a fixed amount of bandwidth without considering how bandwidth usage is by the actual subscriber. In this way, the CoS is an important value for deciding a traffic amount of the corresponding network element.

When classifying the traffic grade, by the information collected about the configuration and connection states of each network element, it will be decided at first whether the corresponding network element can be used or not. In the case the corresponding network element can be used, the traffic grade for each network element is classified by using information calculated by assigning a weight-value to each predefined variable.

The network management system server 10 can perform various network management according to requests from the subscribers through the networks. For example, when there is a request for setting a connection routing path for a new subscriber, a unit or a port with less traffic is selected by the classified traffic grade, and the selected unit or port chooses available subscriber connection virtual path identifier/virtual channel identifier (VPI/VCI) to define a final connection routing path.

Also, when there is a request for extensions of communication lines in a network interval, information for each network element and the traffic grade in the corresponding network element is used to determine whether the communication lines in the network interval will be extended or not.

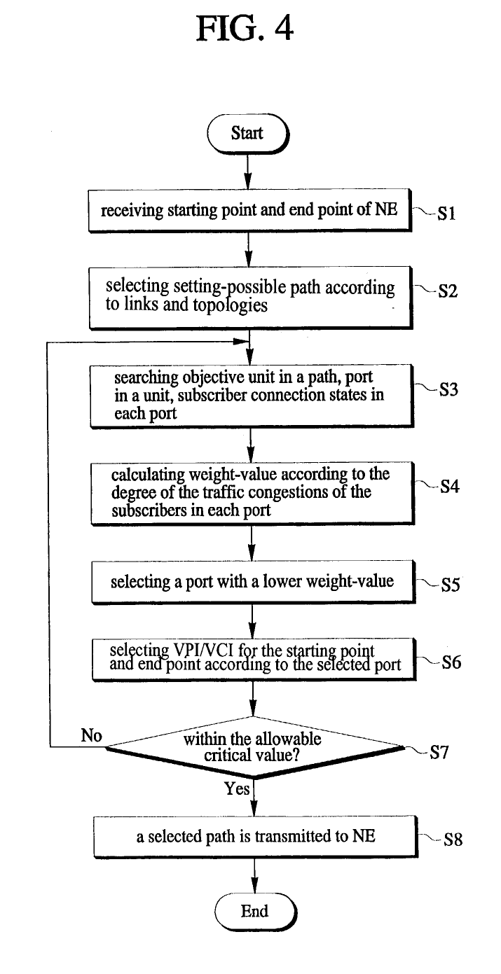

FIG. 4 is a flow chart illustrating an operation of setting a routing path for a new subscriber by using traffic information collected by the network management system server 10 of the present invention. Referring to FIG. 4, the operation flows for setting a routing path for a new subscriber will be illustrated in the following statement by using the traffic information collected by the network management system server 10.

At first, the network management system server 10 receives a starting point and an ending point of a network element for setting a routing path from the network management system client 20 through the networks (step S1). When the starting point and the ending point are inputted, setting-possible paths between the starting point and the ending point are searched through links and topologies (step S2). Several paths can be selected in step S2. For the selected paths, an objective unit in a path, ports in the objective unit, and subscriber connection states in the corresponding port are analyzed (step S3).

When the subscriber connection states in the corresponding port are analyzed, alarm information is analyzed in each unit and each port, and classified in traffic items of each path. Additionally, bandwidth usage for each unit and each port is calculated to select a unit and a port with minimum bandwidth usage.

When selecting an available setting path according to links and topologies, the path through a minimum number of hops between the starting point and the ending point is selected first of all. When several paths exist to go through the same number of hops, the path having a trunk with lower bandwidth usage is selected.

When a rough path is selected, a weight-value for degree of traffic congestion is calculated for the corresponding port and subscriber of each path (step S4). After calculating the weight-value, the port of minimum weight-value is selected (step S5). Additionally, for the selected port, VPI/VCI of the starting point and the ending point are selected (step S6). In the case that more than two VPI/VCI have to be selected, an additional VPI/VCI is selected.

When setting the VPI/VCI of the starting point and the ending point, the traffic descriptor is considered as a primary factor, and a class of service (CoS), a quality of service (QoS) and a type of service (ToS) are considered as a secondary factor for assigning a weight-value. After summing up the assigned weight-value for each subscriber, an average value of the entire weight-value is calculated.

When the VPI/VCI of the starting point and the ending point are defined, it is decided whether the set path satisfies the conditions within the allowed critical value or not (step S7) of bandwidth usage. When the setting path satisfies the allowed critical value, the setting path information is transmitted to the corresponding network element and cross-connection between the corresponding network intervals is defined (step S8).

Until selecting the final path, VPI/VCI of network element/shelf/slot/port is sequentially transmitted to the network management system client 20 for an operator to get the information. Therefore, the operator can select a desired path.

Additionally, the set routing result is stored in the database (DB) 12, and is reflected into the next traffic weight-value.

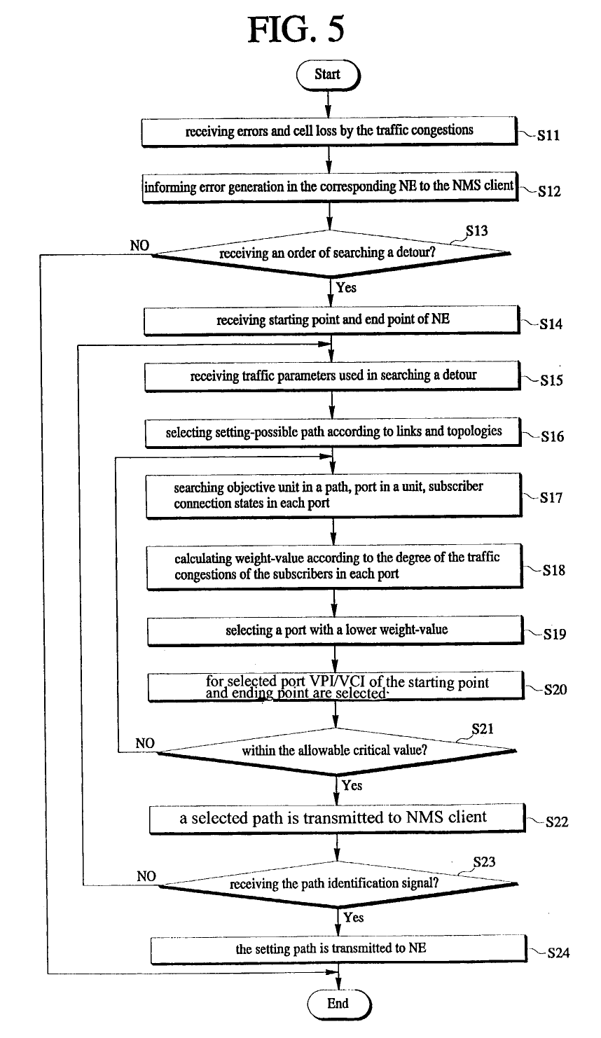

FIG. 5 is a flow chart illustrating procedure of searching a detour when traffic information collected by the network management system server 10 shows errors generated by traffic congestion, according to the preferred embodiment of the present invention.

Referring to FIG. 5, the operation flows for setting a routing path for a new subscriber will be illustrated in the following statements by using traffic information collected by the network management system server 10.

When errors or cell loss are received from the network element generating errors by the traffic congestion (step S11), the network management system client 20 informs the fact of the error generation to the corresponding network element (step S12). Subsequently, the network management system server 10 decides whether an order for searching a detour is received from the network management system client 20 or not (step S13).

When the order of searching a detour is received, the network management system server 10 receives a starting point and an ending point of a network element for setting a routing path from the network management system client 20 through the networks (step S14). Additionally, the network management system server 10 receives a setting for a traffic parameter used in searching the detour from the network management system client 20 (step S15). In this case, the setting for the traffic parameter includes a traffic descriptor, a class of service (CoS), a quality of service (QoS) and a type of service (ToS), according to each subscriber allocated in each network element. In other words, the value inputted from the network management system client 20 is reflected to set a weight-value for each parameter during a detour search.

After the starting point and the ending point of a network element, and each traffic parameter are inputted, an available setting path is searched between the starting point and the ending point according to links and topologies to find an appropriate path (step S16). Therefore, several paths can be selected. For the selected path, an objective unit in each path, ports in each unit, and subscriber connection states in each port are analyzed (step S17).

When the subscriber connection states in each port are analyzed, alarm information is analyzed in each unit and port to be classified as traffic items in each path. When selecting an available path according to links and topologies, the path going through the minimum number of hops between the starting point and the ending point is selected at first. When several paths exist to go through the same number of hops, the path having a trunk with lower bandwidth usage is selected.

When an intermediate path is selected, a weight-value for degree of traffic congestion is calculated for the corresponding port and subscriber of each path (step S18). After calculating the weight-value, the port of minimum weight-value is selected (step S19). Then, for the selected port, VPI/VCI of the starting point and the ending point are selected (step S20).

When setting the VPI/VCI of the starting point and the ending point, the traffic descriptor is considered at first, and a class of service (CoS), a quality of service (QoS), a type of service (ToS) are considered secondly for assigning a weight-value.

When the VPI/VCI of the starting point and the ending point are defined, it is decided whether the setting path satisfies the conditions within the allowed critical value or not (step S21) of bandwidth usage. When the setting path satisfies the allowed critical value, the setting path information is transmitted to the network management system client 20 for informing the selected path. Subsequently, the network management system server 10 decides whether the network management system server 10 receives a path identification signal as an agreement of the path usage from the network management system client 20 or not (step S23).

When the path identification signal is received, the set path is transmitted to the corresponding network element to set a cross-connection between the corresponding network intervals (step S24). On the contrary, when the path identification signal is not received, the mode setting the traffic parameter used in searching a detour is again performed to find another path.

On the contrary, as the network management system client 10 can search traffic information of all network elements provided from the network management system server 10, the network management system client 10 can search and manage various network information.

For example, alarm information can be managed. In the network management system client 20, a network management viewer can be operated to perform the network management by receiving an input from an operator. In more details, a main screen alarm management menu is operated. The menu can be operated by a menu bar, or by a pop-up menu of a network topology icon. In the case of operating as a pop-up menu on the icon, only an alarm of the operated position is displayed, because position information is filtered automatically in the operated position. Other position information can be changed in the filtering condition setting screen.

In the top window of the alarm management, a real time alarm management for the selected position information is selected. The alarm generated from the system is transmitted to the network management system server 10 through an SNMP trap in real time.

Therefore, the network management system server 10 receiving the SNMP trap stores the transmitted alarm information in the database, and transmits the alarm to the session-registered clients. The network management system client 20 displays the transmitted alarm on the screen of the viewer.

Additionally, the network management system client 20 can measure traffic to a network element—a rack—a shelf—a slot (a unit) and port, comprising a network—a sub-network, and channel (VPI/VCI, DLCI, a time slot, IP, AID, etc). For this, the network management system client 20 operates a menu item for “traffic management” in the main screen menu of the viewer according to the input of an operator.

After selecting a rack/shelf icon for performing a traffic measurement in the rack/shelf network element viewer, the pop-up menu is operated by pushing a right button of a mouse. When a traffic management/traffic measurement item is selected in the pop-up menu, the corresponding screen is displayed. Sequentially, after selecting one of the displayed items, traffic measurement can be performed. The measurement item can include the following elements.

Position: (network—sub-network)—network element—rack—shelf—slot (unit)—port

Condition: up link/down link cell count, QoS, PCR/SCR/BT/CDVT

Measurement Operation: Start/Stop

For measuring the traffic in different position information, a desired position item is selected in the network topology tree displayed in a predetermined position of the screen.

The result of traffic measurement is demonstrated to a graph or a table in a predetermined position. The measured traffic information is used in analyzing the traffic trends afterwards by reflecting a configuration management, a connection management, a performance management, and a subscriber management.

Additionally, when a source network element and a destination network element are designated by searching network element information and link-connection information stored in the database of the network management system server 10, a path connecting a minimum number of network element is searched among the paths connecting from the source network element to the destination network element.

Moreover, after searching a quality of service (QoS) value of the port designating the subscriber connection information among the searched paths, the port with minimum QoS is defined. In other words, the port with a minimum weight-value is searched.

Also, the network management system client 20 can set various traffic parameters. In other words, after selecting a shelf of the subscriber ending point in a predetermined tree when connection management screen of the viewer is displayed, a path for an operation can be selected among the paths displayed to set a connection in a viewer.

When a shelf, alarm information, and unit packaging information for an available path are displayed, units through the path are selected to display a port, and dragged (start) or dropped (end) by using a mouse. However, the starting point should be CO/CS. Subsequently, a value is inputted to the setting parameter displayed in the window, or selected. The selectable parameter is in the following statements.

It is possible to set various parameters, such as a selection of VP/VC, Setting ATM VPI/VCI, Automatic identification for duplication, Executing xDSL ending point provision window, Selecting CoS (CBR, rt-VBR, nrt-VBR, UBR, GFR), ToS (POTS, PSTN, ISDN-BRI, Nx64, ADSL, VDSL, SHDSL, LAN, VoIP, VoDSL, VoATM, VoIPoATM).

The present invention analyzes the entire network states through the network management system NMS/EMS to perform a routing, while the conventional route setting depends on network element. Therefore, quick and correct routing setting is possible.

Because analyzed statistical and real time information are used by applying the network management system, various, quick, and easy network cross-connection is performed comparing with the conventional method depending on a routing setting function of the system.

By the network management system, when source and destination network element are inputted, connection information sets all information and an available port/channel VPI/VCI of an intermediate path automatically, and finds an available and a subscriber selectable VPI/VCI. Even though an operator can select the number of the VPI/VCI found by the above method, ten VPI/VCI are basically given for the operator to select one of them.

When a subscriber connection is performed through the network management system in the above statements, traffics are forecasted previously and loads are attenuated by considering various parameters and traffic factors to minimize potential loss.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method of setting a subscriber routing path using traffic information through networks, comprising steps of:
classifying a traffic grade deciding the availability of network elements, after acquiring traffic information of the network elements by using a first information of configuration and connection states of the network elements collected for network management through the networks, and by using a second information calculated by assigning a weight-value to each of a plurality of predefined variables of each the network elements;
selecting a less congested traffic unit or port according to the classified traffic grade in the case of requests for setting a connection routing path for a new subscriber through the networks; and
for the selected traffic unit or port, setting a final connection routing path by selecting an available subscriber connection virtual path identifier/virtual channel identifier (VPI/VCI) for a starting point and an ending point.

2. The method according to claim 1, wherein the network management through the networks in the step of classifying a traffic grade uses traffic information of a network management system/element management system (NMS/EMS).

3. The method according to claim 1, wherein the first information includes at least one of alarm states information, or the number of hops among the network elements.

4. The method according to claim 1, wherein the second information includes at least one of a traffic descriptor, a class of service (CoS), a quality of service (QoS) and a type of service (ToS) for each subscriber allocated to the network elements.

5. The method according to claim 1, wherein the step of classifying the traffic grade comprises the steps of:
deciding an availability in each of the network elements by the first information; and
classifying the traffic grade of the available network elements by the second information.

6. A method for setting a subscriber routing path using traffic information through networks, comprising steps of:
selecting a setting-possible path according to links and topologies between a starting point and an ending point after receiving the starting point and the ending point of network elements for setting a routing path through a network management for the networks;
analyzing objective units in the selected setting-possible path, ports in each unit, and subscriber connection states in each port;
calculating a weight-value for the degree of the traffic congestions of corresponding subscribers in each port;
selecting a port having a lowest weight-value;
setting a virtual path identifier/virtual channel identifier (VPI/VCI) of the starting point and the ending point corresponding to the selected port; and
setting a cross-connection between corresponding network intervals by transmitting selected path information to the corresponding network elements.

7. The method according to claim 6, wherein the step of selecting the setting-possible path according to links and polologies comprises the steps of:
selecting a path going through minimum number of hops between the starting point and the ending point; and
selecting a path having a trunk with a lower bandwidth usage, in the case that several paths go through the same number of hops.

8. The method according to claim 6, wherein the step of analyzing the subscriber connection states in each port analyzes alarm information in each unit/port to classify traffic items in each path.

9. The method according to claim 6, wherein the step of setting the virtual path identifier/virtual channel identifier (VPI/VCI) of the starting point and the ending point considers a traffic descriptor as a primary factor, and a class of service (CoS), a quality of service (QoS) and a type of service (ToS) as a secondary factor to assign weight-value.

10. A method for setting a routing path from a starting point to an end point through a plurality of network elements in a network, comprising steps of:
selecting various possible paths according to link and topology information of each of said network elements;
for each of the selected paths, analyzing an objective unit in the path, ports in the objective unit, and subscriber connection states in the corresponding port;
selecting a rough path according to the result of the analyzing step;
calculating a weight-value according to a degree of traffic congestion of the subscribers in each port;
selecting a port with a lower weight-value; and
for the selected port; selecting an available virtual path identifier/virtual channel identifier (VPI/VCI) of the starting point and the end point to establish a final routing path.

11. The method as set forth in claim 10, further comprising a step of determining whether or not the routing path is for a new subscriber or for searching for a detour.

12. The method as set forth in claim 11, when the routing path is for a new subscriber, further comprising steps of:
determining whether or not bandwidth usage of a selected routing path is within an allowable critical value of bandwidth usage; and
transmitting the selected path to the corresponding network element when bandwidth usage is determined to be within the allowable critical value to define a cross-connection between corresponding network intervals.

13. The method as set forth in claim 11, when searching for a detour, further comprising steps of:
determining whether or not bandwidth usage of a selected routing path is within an allowable critical value of bandwidth usage;
transmitting path information to a network management system client when bandwidth usage is determined to be within the allowable critical value;
determining whether a network management system server receives a path identification signal from the network management system client in response to the transmitted path information; and
transmitting the selected path to the corresponding network element when it is determined that the network management system server receives the path identification signal from the network management system client, to define a cross-connection between corresponding network intervals.

14. The method as set forth in claim 13, further comprising a step of:
receiving, by the network management system server, a setting for a traffic parameter used in searching the detour from the network management system client prior to said step of selecting various possible paths and when it is determined that said network management system server did not receives the path identification signal from said network management system client.

15. The method as set forth in claim 14, wherein said traffic parameter includes a traffic descriptor, a class of service (CoS), a quality of service (QoS) and a type of service (ToS), according to each subscriber allocated in each network element.
